(19) United States
(12) Patent Application Publication
(10) Pub. No.: US 2007/0281064 A1
(43) Pub. Date: Dec. 6, 2007

(54) High Fiber, Reduced Effective Carbohydrate Corn-Based Food Formulations

(76) Inventors: Ansui Xu, Carmel, IN (US); Brian Dahlman, Oswego, IN (US); Michael Vanhouten, Carmel, IN (US); James Pause, Avon, IN (US)

Correspondence Address: FISH & RICHARDSON P.C., PO BOX 1022, MINNEAPOLIS, MN, 55440-1022, US

(21) Appl. No.: 10/593,398

(22) PCT Filed: Mar. 18, 2005
(86) PCT No.: PCT/US05/09064

§ 371 Date: Jul. 23, 2007

Related U.S. Application Data
(60) Provisional application No. 60/554,411, filed on Mar. 19, 2004.

(51) Int. Cl. A21D 13/02; A21D 2/38

(52) U.S. Cl. 426/555; 426/560

(57) ABSTRACT

High fiber, reduced effective carbohydrate formulations useful for preparing food products such as tortillas, tortilla chips, taco shells, corn based snacks, breakfast cereal, and the like comprising about 10-80% masa corn flour; about 10-60% ground corn bran; about 1-20% pre-gelatinized flour and/or pre-gelatinized starch; about 0-60% ground corn germ; about 0-50% corn gluten meal; and about 0-30% vital wheat gluten or wheat protein isolate.

### FIELD OF THE INVENTION

The present invention is directed to high fiber, reduced effective carbohydrate corn-based food formulations.

### DESCRIPTION OF RELATED ART

There is a demand for reduced effective carbohydrate foods due to certain weight-control diet programs such as Atkins. There is also a demand for foods that contain a high level of total dietary fiber, e.g., for colon health and for potential cholesterol reducing benefits. A number of food manufacturers are marketing low carbohydrate tortilla chips. The formulations used typically contain (1) soy protein isolate and/or soy protein concentrate and (2) masa corn flour or corn meal or tapioca starch, and may additionally contain (3) rice flour, black beans, flax seeds, sesame seeds, or sunflower seeds; and/or (4) oat bran or soy fiber. For example, Frito-Lay has announced low carbohydrate tortilla chips made from corn and soy protein isolates.

The following table summarizes several low carbohydrate tortilla chip products currently marketed in the U.S.

| | | | | Total | | | |
|---|---|---|---|---|---|---|---|
| Product | Description | Ingredient Composition | Total Fat | Carb | Fiber | Sugar | Protein |
| Atkins | Original, | Nacho: Soy protein concentrate, tapioca starch, | 3 g | 8 g | 3 g | 0 g | 13 g |
| Crunchers | BBQ, Nacho, | sunflower oil, nacho seasoning (cheddar cheese | | | | | |
| | Sour Cream | powder [(partially hydrogenated soybean oil, | | | | | |
| | & Onion | whey, cheddar cheese (pasteurized cultured milk, | | | | | |
| | | salt, enzyme), maltodextrin, salt, nonfat dry milk, | | | | | |
| | | disodium phosphate, monosodium glutamate, citric | | | | | |
| | | acid, artificial colors (including F.D.&C. yellow #5 | | | | | |
| | | and F.D.&C. yellow #6), lactic acid)], buttermilk | | | | | |
| | | powder, salt, romano and parmesan cheese | | | | | |
| | | powders (partially skim milk, culture, salt, | | | | | |
| | | enzymes, disodium phosphate), tomato powder, | | | | | |
| | | monosodium glutamate, natural and artificial | | | | | |
| | | flavors, onion powder, lactic acid, garlic powder, | | | | | |
| | | citric acid, spice and not more than 2% vegetable | | | | | |
| | | oil and silicon dioxide added as processing aids), | | | | | |
| | | salt. | | | | | |
| Carb Fit | Original only | Soy concentrate, corn, expeller pressed canola oil, | 8 g | 9 g | 4 g | 0 g | 9 g |
| Tortilla | but make | and/or safflower oil, and/or sunflower oil, salt. | | | | | |
| Chips | Carb Fit | | | | | | |
| | Twirls In | | | | | | |
| | seasoned | | | | | | |
| | varieties | | | | | | |
| CarbSense | Original, Pico | Nacho: Masa corn flour, soy protein concentrate | 8 g | 12 g | 4 g | 0 g | 5 g |
| | de Gallo, | (non-gmo), safflower oil, rice flour, black beans, | | | | | |
| | Nacho & | oat bran, sesame seeds, flax seeds, seasonings | | | | | |
| | Habanero | (salt, cheese powder (milk, cheese cultures, salt, | | | | | |
| | | enzymes)), buttermilk, whey, onion, garlic, spices, | | | | | |
| | | tomato powder, natural flavors, sugar, extractives | | | | | |
| | | of paprika & turmeric, citric acid, lactic acid). | | | | | |
| Keto Foods | Classic Corn, | Nacho: Soy protein isolate, soy-bean oil, soy | 8 g | 8 g | 4 g | 0 g | 12 g |
| | Cool Ranch, | protein concentrate, soy fiber, corn meal, | | | | | |
| | Nacho | seasoning (contains aged romano, cheddar & | | | | | |
| | | parmesan cheese, buttermilk, whey, salt, tomato | | | | | |
| | | powder, onion powder, garlic powder, natural | | | | | |
| | | flavor, citric acid, annatto, spice, lactic acid) and | | | | | |
| | | soy lecithin. | | | | | |
| Genisoy | Lightly | Masa corn flour, soy protein concentrate (identity | 8 g | 12 g | 4 g | 0 g | 5 g |
| Tortilla | Salted, Zesty | preserved), expeller-pressed monounsaturated | | | | | |
| Chips | Habanero, | safflower oil or sunflower oil, black beans, rice | | | | | |
| | Nacho | flour, oat bran, sesame seeds, flax seeds, sunflower | | | | | |
| | Cheese and | seeds, seasonings (salt, cheese powder [Cheddar | | | | | |
| | Fiesta Salsa | and Romano cheese (milk, cheese cultures, salt | | | | | |
| | | and enzymes)], buttermilk, whey, onion, garlic, | | | | | |
| | | spices, tomato powder, natural flavors, sugar, | | | | | |
| | | extracts of paprika, & turmeric, citric acid and | | | | | |
| | | lactic acid. | | | | | |

There remains a need for alternative reduced carbohydrate corn-based formulations for food products. It would be desirable to develop a formulation which does not require the presence of soy proteins, which can adversely affect food taste and texture and also are potential allergens. It would be particularly desirable to develop a formulation which also could be produced at lower cost than that associated with presently available formulations.

### SUMMARY OF THE INVENTION

According to one aspect, the present invention is directed to high fiber, reduced effective carbohydrate food formulations comprising:

a) about 10-80% masa corn flour;

b) about 10-60% ground corn bran; and

c) about 1-20% pre-gelatinized flour and/or pre-gelatinized starch.

According to another aspect of the invention, high fiber, reduced effective carbohydrate formulations comprise:

a) about 10-80% masa corn flour;

b) about 10-60% ground corn bran;

c) about 1-20% pre-gelatinized flour and/or pre-gelatinized starch;

d) up to about 60% ground corn germ;

e) up to about 50% corn gluten meal; and

f) up to about 30% vital wheat gluten or wheat protein isolate.

According to an alternative embodiment of the present invention, a reduced effective carbohydrate food formulation comprises:

a) about 10-80% masa corn flour;

b) about 10-60% ground corn germ; and

c) about 1-20% pre-gelatinized flour and/or pre-gelatinized starch.

The formulations of the present invention are particularly suitable for preparing food products such as tortillas, tortilla chips, taco shells, corn based snacks, breakfast cereals, and the like. Preferred compositions of the present invention have improved machinability or handling properties compatible with equipment currently used to produce tortillas, tortilla chips and taco shells. These properties provide reduced propensity for sheeting and baking problems as a result of dough stiffness and stickiness normally associated with using soy protein isolate and soy protein concentrate.

Compared with formulations containing soy protein isolates and soy protein concentrates, formulations of the present invention have the potential to yield food products exhibiting better sensory properties, for example without the beany taste and hard texture typically associated with products containing soy protein formulations. In addition, the formulations of the present invention potentially can be produced at lower cost than that associated with presently available formulations.

### DETAILED DESCRIPTION OF THE INVENTION

The present invention uses formulations containing corn bran and masa flour and a pre-gelatinized flour or pre-gelatinized starch, and optionally other ingredients such as corn germ, corn gluten meal and/or vital wheat gluten (VWG) or wheat protein isolate to make food products such as tortillas, tortilla chips, taco shells, corn-based snacks, breakfast cereals, and the like. Unless otherwise clear from the context, all percentages described herein refer to percent by weight based on the total dry weight of the formulation.

The term “effective carbohydrates,” as used herein, refers to the difference between total carbohydrates and total dietary fiber contents. Typically, effective carbohydrates include starch and sugars. Whether a formulation has “reduced effective carbohydrates,” as used herein, can be determined by calculating the percent reduction in effective carbohydrates of the formulation as compared with “equivalent normal carbohydrates.” Equivalent normal carbohydrates is a predicted effective carbohydrates percentage that would be present if a regular masa flour were used with the same fat and moisture in the food product. Preferred reduced effective carbohydrate formulations have an effective carbohydrate reduction of at least about 10%, preferably at least about 20%, more preferably at least about 30%, even more preferably at least about 40%, and yet even more preferably at least about 50%.

Equivalent normal total dietary fiber refers to a predicted total dietary fiber percentage that would be present if a regular masa flour were used with the same fat and moisture in the food product. Total dietary fiber increase refers to the percent increase in total dietary fiber of a given formulation as compared with the equivalent total dietary fiber. In the embodiments in which the formulation has increased total dietary fiber, the percent of total dietary fiber increase usually is at least about 10% and preferably at least about 20%, more preferably at least about 30%, even more preferably at least about 40%, and yet even more preferably at least about 50%. Some formulations of the present invention exhibit total dietary fiber increases of 100%, 200%, and even 300% or more.

Preferred formulations of the present invention have the following composition:
a) 10-80%, preferably 15-60%, and more preferably 20-50% masa corn flour;
b) 10-60%, preferably 15-45%, and more preferably 25-40% ground corn bran, which may be prepared with or without cooking before grinding; and
c) 1-20%, preferably 3-15%, and more preferably 5-12% pre-gelatinized flour or pre-gelatinized starch;
d) 0-60%, preferably 15-40%, and more preferably 20-35% ground corn germ, which may be prepared with or without pretreatments of heating or toasting;
e) 0-50%, preferably 5-15%, corn gluten meal; and
f) 0-30%, preferably 5-20%, vital wheat gluten (VWG) or wheat protein isolate.

Optionally, the formulation contains other components such as fibers from sources other than corn bran, protein products, other ground grains or legumes, and/or gums. Although soy protein may be present, preferred formulations of the invention are free or substantially free of soy protein.

In an alternative embodiment of the invention, a reduced effective carbohydrate food formulation comprises:

a) about 10-80% masa corn flour;

b) about 10-60% ground corn germ; and

c) about 1-20% pre-gelatinized flour and/or pre-gelatinized starch.

This formulation also is useful for preparing food products which have reduced effective carbohydrates, although which are less high in fiber. As in the previous embodiments, the formulation can be used to prepare food products such as tortillas, tortilla chips, taco shells, corn-based snacks, breakfast cereals, and the like. In addition, other components (as herein described) may be present in the formulation.

Suitable masa flour is commercially available and/or can be readily prepared by persons of ordinary skill. The masa corn flour can be made with nixtamalization followed by drying, grinding and sizing. The masa flour alternatively can be made with grinding corn first, followed by cooking (with or without lime), drying and sizing, e.g., as described in U.S. Pat. No. 6,068,873. The masa flour can have a wide range of granulations. Alternatively, nixtamalized dough or cooked masa can be used directly, e.g., without need to dry the dough into flour. In this case, suitable weights of nixtamalized dough or cooked masa to be used can be calculated based on percentages of masa flour described in this invention with moisture adjustments. For example, in a particular formulation, if 100 lbs. of masa flour is to be used and the masa flour has a moisture content of 10%, one can use 187.5 lbs. of a nixtamalized dough with 52% moisture while adjusting water addition accordingly to make a suitable dough with the rest of ingredients as described in this invention. The following equation can be used to calculate the dough weight:
W_{d}=W_{f}(100−M_{f})/(100−M_{d})
where W_{d} is weight of nixtamalized dough or cooked cook masa to be determined, W_{f} is weight of masa flour described in this invention, M_{f} is moisture percentage of masa flour, which is typically 9-14% (% is not used in the equation), and M_{d} is moisture of nixtamalized dough or cooked cook masa, which is typically 50-60% (% is not used in the equation).

Corn bran can be processed using methods similar to those described in U.S. Pat. No. 6,383,547, U.S. Pat. No. 6,056,990 and U.S. Pat. No. 6,610,349. The corn bran can also be made with grinding without cooking. The corn bran can be prepared either from a dry corn milling process or from a wet-milling process. U.S. Pat. No. 6,383,547 to Delrue et al. discloses a process for preparing aspirated bran as a flour additive. U.S. Pat. No. 6,056,990 to Delrue et al. describes milled cereal by-product which is an additive for flour and dough. U.S. Pat. No. 6,610,349 to Delrue et al. discloses milled cereal by-product which is an additive for increasing total dietary fiber. Either ground bran, ground germ, or both can be cooked together with ground endosperm. Other variations are possible. For example, unground bran and intact germ can be cooked together with ground endosperm, followed by grinding.

Pre-gelatinized flour can be made with cooking corn flour or a coarser corn meal such as soft meal or cones, followed by grinding and drying. Cooking can be accomplished with any type of suitable cooking methods such as steam cooking, drum cooking or extrusion cooking. A pre-gelatinized starch can be used instead of or in combination with the pre-gelatinized flour. Non-limiting examples of pre-gelatinized starch include corn starch, wheat starch, potato starch, rice starch, tapioca starch, barley starch, oat starch, rye starch, sorghum starch, sago starch, sweet potato starch, and pea starch. Alternatively, a pre-gelatinized flour of another grain from any source, including but not limited to a pre-gelatinized wheat flour, a pre-gelatinized oat flour, a pre-gelatinized barley flour, a pre-gelatinized rye flour, a pre-gelatinized rice flour, and a pre-gelatinized sorghum flour, can be used in place of or combined with pre-gelatinized corn flour.

Ground corn germ can be made by a method similar to the process described in U.S. Pat. No. 6,638,558 except for the need to be cooked with lime. Thus, the corn germ can be separated from corn endosperm in the dry milling process by a degerminator, followed by separation through aspirators, roll mills and sieves. The germ then can be ground in a hammer mill to a desirable granulation. The source of germ can be from a dry corn milling process or a wet corn milling process. Germ from other grains or legumes can also be used.

Alternatively, germ (ground or intact), ground endosperm, and ground bran can be cooked together followed by drying and grinding, for example in accordance with the process described in U.S. Pat. No. 6,068,873. Corn bran can be from a dry milling process or a wet milling process. Corn bran can be ground without cooking. Germ can be from a dry milling process or a wet milling process.

Granulations of all the ingredients can be varied without departing from the spirit or scope of the invention. It will be appreciated by persons skilled in the art that too coarse a granulation can cause sheeting problems on a conventional tortilla line but may be acceptable on other lines, such as extrusion. Various other ingredients can be added to affect texture, taste, or other characteristics of the formulation without departing from the spirit of scope of the invention.

The compositions described herein are particularly useful for the preparation of tortillas, tortilla chips, taco shells or snack foods. These and other food products can be made in accordance with well-known processes, which form no part of the present invention.

### EXAMPLES 1-9

Tortilla chips were prepared having the compositions shown in the following table.

| | | | Pre- | Cooked | | | |
|---|---|---|---|---|---|---|---|
| | | | gelati- | and | | | |
| | | | nized | Ground | | Corn | |
| Ex- | Masa | Masa | Corn | Corn | Ground | gluten | |
| ample | Type | Flour | Flour | Bran | Germ | meal | VWG |
| 1 | A | 50% | 5% | 20% | 20% | 5% | |
| 2 | A | 50% | 5% | 20% | 20% | | 5% |
| 3 | A | 41% | 6% | 27% | 27% | | |
| 4 | A | 34% | 7% | 33% | 21% | | 5% |
| 5 | A | 17% | 8% | 33% | 27% | | 15% |
| 6 | A | 32% | 7% | 34% | 22% | | 5% |
| 7 | A | 29% | 7% | 37% | 27% | | |
| 8 | B | 29% | 7% | 37% | 27% | | |
| 9 | C | 29% | 7% | 37% | 27% | | |

All masa flour products were made by Cargill Dry Corn Ingredients. Masa type A is a medium-fine yellow masa flour with a granulation of 12% above US 20M and 55% below US60M. Masa type B is a fine white masa flour with a granulation of about 30% above 60M. Masa type C is a fine yellow masa flour with a granulation of about 30% above 60M. Pre-gelatinized corn flour was made with extrusion cooking and had a granulation of about 7% above 60M.

Cooked and ground corn bran was made using a procedure similar to that described in U.S. Pat. Nos. 6,056,990, 6,610,349 and 6,383,547 to Delrue et al. with some modifications. Bran separated from corn kernels using a degerminator and aspirators was soaked in water and heated to cook the bran without lime. The cooked bran was then dried in a flash dryer and ground in a micron grinder to a granulation of essentially 100% through 40M.

Ground germ was made with a procedure containing steps of removing germ from kernels using a degerminator, aspiration cleaning, roll mill flattening, sifting for purification, and hammer mill grinding and sifting for sizing. The ground germ had a granulation of about 35% above 60M.

Corn gluten meal is a product of the corn wet-milling industry and is commercially available. Vital wheat gluten is a product of the wheat wet-milling process and is commercially available, for example, from Cargill, Inc., Minneapolis, Minn. and Midwest Grain Products, Inc., Atchison, Kans.

The following table summarizes the processing and product properties of the tortilla chips. Water level is based on dry mix weight.

| | | | | | | | | | | | Equiv. | |
|---|---|---|---|---|---|---|---|---|---|---|---|---|
| | | | | | | | | | Effective | Total | Total | Total |
| | | | | | Chip | Chip | Effective | Equivalent | Carbs | Dietary | Dietary | Dietary |
| | Water | | | | Moisture | Fat | Carbs | Normal | Reduction | Fiber | Fiber | Fiber |
| Example | Level | Dough | Sheeting | Baking | (%) | (%) | (%) | Carbs (%) | (%) | (%) | (%) | Increase |
| 1 | 72% | Ok | Ok | Ok | 3.11 | 26.8% | 41.7 | 57.7 | 27.7% | 16.3 | 5.7 | 186% |
| 2 | 77% | Ok | Ok | Ok | 3.47 | 23.0% | 43.7 | 60.5 | 27.8% | 17.1 | 6.0 | 185% |
| 3 | 79% | Ok | Ok | Ok | 2.92 | 30.4% | 37.4 | 55.0 | 31.9% | 19.6 | 5.4 | 263% |
| 4 | 77% | Ok | Ok | Ok | 3.84 | 25.1% | 36.8 | 58.6 | 37.2% | 23.8 | 5.8 | 310% |
| 5 | 77% | Elastic | Harder | Ok | 2.78 | 24.3% | 30.5 | 59.9 | 49.0% | 23.1 | 5.9 | 292% |
| 6 | 79% | Ok | Ok | Ok | 2.27 | 21.6% | 38.4 | 62.3 | 38.4% | 26.1 | 6.2 | 321% |
| 7 | 79% | Slightly | Ok | Ok | 1.50 | 37.6% | 30.6 | 50.0 | 38.8% | 21.4 | 5.0 | 328% |
| | | Sticky | | | | | | | | | | |
| 8 | 75% | Ok | Ok | Ok | 2.47 | 37.7% | 30.3 | 49.5 | 38.8% | 21.2 | 4.9 | 333% |
| 9 | 75% | Ok | Ok | Ok | 2.62 | 33.3% | 32.4 | 52.9 | 38.8% | 22.6 | 5.2 | 335% |

In the preceding table and the table below, equivalent normal carbs (%) is the predicted effective carbohydrates percentage in the product if a regular masa flour were used in place of the stated formula with the same fat and moisture in the chips. The prediction was based on the composition of the typical masa flour. Effective carbs reduction (%) is percent reduction in effective carbohydrates of the stated examples as compared with the equivalent normal carbs. Similarly, equivalent total fiber (%) is the predicted effective total dietary fiber percentage that would be present if a regular masa flour were used with the same fat and moisture in the food product. Total dietary fiber increase is the percent increase in total dietary fiber of the stated examples as compared with the equivalent total dietary fiber.

The dry ingredients were pre-blended for 1-2 minutes and mixed for about 5 minutes after adding water. The dough was sheeted into a triangle shape and baked in a gas oven at about 500-800° F. for about 37 seconds. The baked chips were cooled for about 10 seconds to 4 minutes and then fried in soybean oil or canola oil at about 350° F. for 30-60 seconds.

All formulations had good processing properties during sheeting and baking. The resultant chips had acceptable color and appearance and eating characteristics, including taste and texture.

### EXAMPLES 10-16

Taco shells were prepared with a procedure similar to that used for making tortilla chips. In fact, the formulations for taco shells in the table below can also be used for making tortillas and tortilla chips. Tortillas can be made in the same manner except that there is no need for frying. Tortilla chips can be made in the same manner except that the dough or the tortillas can be cut into the desirable shape and size for typical tortilla chips and tortilla chips are fried to have a lower moisture content than taco shells.

Taco shells need to be folded after baking into a frying mold to be fried into the taco shell shape. One challenge for the formulations is to allow sufficient flexibility in baked tortillas so that folding can be accomplished without breakage or cracking of the tortillas.

| | | | | Cooked | | | | | |
|---|---|---|---|---|---|---|---|---|---|
| | | | | and | | | | | |
| | | | | Ground | | Toasted | Corn | | |
| | Masa | Masa | Pre-gelatinized | Corn | Ground | Ground | gluten | | Guar |
| Example | Type | Flour | Corn Flour | Bran | Germ | Germ | meal | VWG | Gum |
| 10 | A | 55% | 10% | 15% | | 10% | 10% | | |
| 11 | A | 42% | 10% | 15% | 15% | | 10% | 8% | |
| 12 | D | 50% | 5% | 20% | 20% | | 5% | | |
| 13 | A | 32% | 7% | 34% | 27% | | | | |
| 14 | E | 28% | 10% | 34% | 22% | | | 5% | |
| 15 | E | 31.5% | 8% | 34% | 22% | | | 5% | 0.5% |
| 16 | E | 29% | 10% | 41% | 15% | | | 5% | |

Masa type D is a fine white masa flour with about 25% above 60M. Masa type E is a coarse yellow masa flour with a granulation of about 25% above 20M and about 30% through 60M. Toasted ground germ was obtained from Quali Tech, Inc., Chaska, Minn. Guar Gum was obtained from TIC Gums, Inc., Belcamp, Md. The following table summarizes the processing and product properties of the taco shells.

| | | | | | | | | | | | Eq | |
|---|---|---|---|---|---|---|---|---|---|---|---|---|
| | | | | | Taco | | | | | Total | Total | Total |
| | | | | | Mois- | | Effective | Equivalent | Effective | Dietary | Dietary | Dietary |
| | Water | | | | ture | Taco | Carbs | Normal | Carbs | Fiber | Fiber | Fiber |
| Ex. | Level | Dough | Sheeting | Baking | (%) | Fat (%) | (%) | Carbs (%) | Reduction | (%) | (%) | Increase |
| 10 | 77% | Ok | Slightly | Ok | 4.1 | 35.6 | 38.4 | 50.3 | 23.6% | 11.1 | 5.0 | 122% |
| | | | sticky | | | | | | | | | |
| 11 | 65% | Firm | Thick | Floury | 4.23 | 38.8 | 32.0 | 47.7 | 33.0% | 10.7 | 4.7 | 128% |
| | | | | appearance | | | | | | | | |
| 12 | 81% | Good | Good | Needed to | 6.11 | 21.5 | 43.4 | 60.0 | 27.7% | 17.0 | 5.9 | 188% |
| | | | | lower | | | | | | | | |
| | | | | Temp. to | | | | | | | | |
| | | | | be | | | | | | | | |
| | | | | flexible | | | | | | | | |
| 13 | 79% | Good | Ok | Ok | 3.16 | 28.4 | 35.7 | 56.4 | 36.7% | 22.9 | 5.6 | 309% |
| 14 | 75% | Ok | Ok | Ok | 4.89 | 26.9 | 34.8 | 56.6 | 38.4% | 22.0 | 5.6 | 293% |
| 15 | 79% | Firm | Fair | Ok | 2.75 | 27.4 | 35.1 | 57.5 | 39.0% | 22.6 | 5.7 | 296% |
| 16 | 79% | Ok | Ok, | Ok | 2.32 | 25.5 | 35.9 | 59.2 | 39.5% | 24.9 | 5.9 | 322% |
| | | | Slower | | | | | | | | | |

The dry ingredients were pre-blended for 1-2 minutes and mixed for about 5 minutes after adding water. The dough was sheeted into a round shape with a diameter of about 5-6 inches and baked in a gas oven at about 500-800° F. for about 37 seconds. The baked tortillas were cooled for about 10 seconds and then fried after being placed in a mold, in soybean oil or canola oil at about 350° F. for 30-60 seconds.

The formulations had acceptable processing properties in terms of sheeting, baking and folding. The formulations produced acceptable taco shells with good eating characteristics, acceptable color and appearance and fair sturdiness.

While particular embodiments of the present invention have been described and illustrated, it should be understood that the invention is not limited thereto since modifications may be made by persons skilled in the art. The present application contemplates any and all modifications that fall within the spirit and scope of the underlying invention disclosed and claimed herein.

1. A high fiber, reduced effective carbohydrate food formulation comprising:
a) about 10-80% masa corn flour;
b) about 10-60% ground corn bran; and
c) about 1-20% of pre-gelatinized flour, pre-gelatinized starch, or both.

2. The formulation of claim 1 further comprising:
d) up to about 60% ground corn germ;
e) up to about 50% corn gluten meal; and
f) up to about 30% vital wheat gluten or wheat protein isolate.

3. The formulation of claim 1, which comprises:
a) about 15-60% masa corn flour;
b) about 15-45% ground corn bran;
c) about 3-15% of pre-gelatinized flour, pre-gelatinized starch, or both;
d) about 15-40% ground corn germ;
e) about 5-15% corn gluten meal; and
f) about 5-20% vital wheat gluten or wheat protein isolate.

4. Tortillas comprising the formulation of claim 1.

5. Tortilla chips comprising the formulation of claim 1.

6. Taco shells comprising the formulation of claim 1.

7. A corn based snack comprising the formulation of claim 1.

8. Breakfast cereal comprising the formulation of claim 1.

9. The formulation of claim 3, which comprises:
a) about 20-50% masa corn flour;
b) about 25-40% ground corn bran;
c) about 5-12% of pre-gelatinized flour, pre-gelatinized starch, or both;
d) about 20-35% ground corn germ;
e) about 5-15% corn gluten meal; and
f) about 5-20% vital wheat gluten or wheat protein isolate.

10. Tortillas comprising the formulation of claim 9.

11. Tortilla chips comprising the formulation of claim 9.

12. Taco shells comprising the formulation of claim 9.

13. A corn based snack comprising the formulation of claim 9.

14. Breakfast cereal comprising the formulation of claim 9.

15. A high fiber, reduced effective carbohydrate food formulation comprising:
a) about 10-80% masa corn flour;
b) about 10-60% ground corn germ; and
c) about 1-20% pre-gelatinized flour and/or pre-gelatinized starch.

16. Tortillas comprising the formulation of claim 15.

17. Tortilla chips comprising the formulation of claim 15.

18. Taco shells comprising the formulation of claim 15.

19. A corn based snack comprising the formulation of claim 15.

20. Breakfast cereal comprising the formulation of claim 15.
